(19) United States
(12) Patent Application Publication
(10) Pub. No.: US 2026/0255095 A1
(43) Pub. Date: Aug. 27, 2026

(54) EARTIPS WITH AN INSET SILICONE FOAM SECTION

(71) Applicant: Apple Inc., Cupertino, CA (US)

(72) Inventors: Sarah B. Gysbers, Boulder, CO (US); Matthew J. Zaverl, Truckee, CA (US); Lee M. Panecki, Scotts Valley, CA (US); Samuel J. Heasley, Sunnyvale, CA (US); Scott C. Grinker, Belmont, CA (US); Jarrett B. Lagler, San Francisco, CA (US); Andrew R. Dawn, Roseville, CA (US)

(73) Assignee: Apple Inc., Cupertino, CA (US)

(21) Appl. No.: 19/268,253

(22) Filed: Jul. 14, 2025

Related U.S. Application Data
(60) Provisional application No. 63/763,503, filed on Feb. 26, 2025.

(51) Int. Cl. H04R 1/10; H04R 1/28

(52) U.S. Cl. CPC H04R 1/1016; H04R 1/1058; H04R 1/1083; H04R 1/2803; H04R 2460/01

(57) ABSTRACT

A deformable eartip comprising: a monolithic silicone rubber eartip body comprising: an annular inner body defining a sound channel through the deformable eartip, and an annular outer flange integrally formed with and surrounding the annular inner body in a spaced apart relationship with the annular inner body; a closed-cell silicone foam section formed on and completely surrounding a portion of an outer surface of the annular inner body and extending to the outer flange thereby filling in space between the annular inner body and outer flange; a deflection zone formed between the annular outer flange and the inner wall; and an annular rigid frame coupled to the annular inner body and defining a central frame opening formed through the frame that is aligned with the sound channel formed through the annular inner body.

### CROSS-REFERENCES TO OTHER APPLICATIONS

This application claims priority to U.S. Provisional Application No. 63/763,503, for “EARTIPS WITH AN INSET SILICONE FOAM SECTION” filed on Feb. 26, 2025, which is herein incorporated by reference in its entirety for all purposes.

### BACKGROUND

Earphones, sometimes referred to as ear-fitting headphones, can be used with a wide variety of electronic devices, such as portable media players, smart phones, tablet computers, laptop computers, stereo systems, along with many other types of devices. Earphones have historically included a relatively small housing configured to be placed substantially within a user's ear, an audio driver that outputs sound through an acoustic port in the housing, and a cable that electrically connects the in-ear listening device to an audio source. Over the last decade and more, wireless earphones that do not include a cable have become increasingly popular.

Earphones include both earbuds that fit within a user's outer ear facing the ear canal without being inserted into the ear canal, and in-ear headphones, sometimes referred to as canal phones, which include a deformable eartip that is inserted in the ear canal itself. The eartip includes a centrally located sound channel that directs sound generated by the audio driver directly into a user's ear canal. A properly sized eartip can both support the in-ear headphone within a user's ear and form a seal with the user's ear canal and/or ear cavity enhancing sound quality and reducing outside noises.

While many different types of eartips have been developed and used commercially over the years, improvements are desirable.

### BRIEF SUMMARY

Some embodiments of the present disclosure pertain to eartips that provide improved passive attenuation for in-ear headphones reducing background noise that might be present in the environment the eartips are used in from reaching the ear drum of the user. Embodiments provide improved passive attenuation without sacrificing comfort, stability or the ability of the eartip to provide a strong acoustic seal. While eartips according to the embodiments described herein can be used with any in-ear headphones, they are particularly beneficial for in-ear headphones that include an active noise cancellation (ANC) feature. For example, some ANC systems are more effective at blocking low frequency sounds than they are at canceling higher frequency sounds. Embodiments described herein can be used with in-ear headphones having ANC systems to increase the passive attenuation of mid and high frequency sounds from background noise thereby improving the ANC capability of the in-ear headphones.

Eartips according to some embodiments include a thin silicone skin along with a silicone foam layer inlaid onto in areas important to the passive attenuation capability of the eartip. The layer of silicone foam can block sounds in the mid and high frequencies from traveling through the eartip to a user's ear drum and can be added in a manner that does not noticeably increase the stiffness of the eartip and thus not detract from comfort or fit. In some embodiments, the silicone foam layer can be created by adding a mixture of liquid silicone rubber and thermoplastic microspheres at selected locations on the eartip and subsequently heating the eartip to expand the microspheres.

According to some embodiments, a deformable eartip includes: a monolithic silicone rubber eartip body comprising: (i) an annular inner body having an inner surface extending between first and second opposing ends thereby defining a sound channel through the deformable eartip, (ii) and an annular outer flange integrally formed with and surrounding the first end of the annular inner body and extending towards the second end of the annular inner body in a spaced apart relationship with the annular inner body; a closed-cell silicone foam section formed on and completely surrounding a portion of an outer surface of the annular inner body adjacent to the first end and extending to the outer flange thereby filling in space between the annular inner body and outer flange, wherein the closed-cell silicone foam layer and annular inner eartip body combine to form a portion of an inner wall of the eartip that surrounds the sound channel; a deflection zone formed between the annular outer flange and the inner wall; and an annular rigid frame coupled to the second end of the annular inner body and defining a central frame opening formed through the frame that is aligned with the sound channel formed through the annular inner body.

In additional embodiments, a deformable eartip is provided that includes: an annular inner eartip body having an inner surface extending between first and second opposing ends thereby defining a sound channel through the eartip; an annular outer flange integrally formed with and surrounding the first end of the inner eartip body and extending towards the second end of the inner eartip in a spaced apart relationship with the annular inner eartip body; a closed-cell silicone foam section formed on and completely surrounding an outer surface of the inner eartip body and extending to the outer flange thereby filling in space between the inner eartip body and outer flange near a tip of the eartip, whereby the closed-cell silicone foam section and annular inner eartip body combine to form a portion of an inner wall of the eartip that surrounds the sound channel; and a deflection zone formed between the annular outer flange and the inner wall, the deflection zone being sized and shaped to allow the annular outer flange to be compressed and bent into the deflection zone when the deformable eartip is inserted into an ear canal.

In various implementations, deformable eartips according to embodiments disclosed herein can include one or more of the following features. The closed-cell silicone foam section can include a plurality of microspheres having a mean particle size between 60 and 120 microns. The closed-cell silicone foam section can be formed from a mixture of thermoplastic microspheres and liquid silicone rubber. The thermoplastic microspheres in the mixture can have a mean particle size between 5-40 microns prior to being heated and expanded. The monolithic silicone rubber eartip body can have a density between 1.1 and 1.8 grams/cm³. The closed-cell silicone foam section can have a density that is between 10-60 percent lower than the density of the monolithic silicone rubber eartip body. The closed-cell silicone foam section can have a density between 0.7 and 0.9 grams/cm³. The eartip can be formed with a triple shot injection molding process in which one shot forms a rigid frame, a second shot forms the outer flange and the inner eartip body and a third shot forms the closed-cell silicone foam section. The deflection zone can have a width, at its widest point, of at least 3 mm and a length of at least 5 mm. The annular rigid fame can be made from glass-reinforced nylon.

In still other embodiments, an in-ear headphone is provided that includes: a housing defining a cavity and an acoustic opening; an acoustic driver positioned within the housing and operatively coupled to emit sound through the acoustic opening; and a deformable eartip removably attached to the housing and aligned with the acoustic opening where the deformable eartip can be an eartip as described herein.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 is a simplified illustration of an exemplary system of portable electronic devices including a host device configured as a smart phone, a charging case, and a pair of in-ear headphones earbuds according to some embodiments;

FIG. 2 is a simplified block diagram of an in-ear headphone according to some embodiments;

FIG. 3A is a simplified side-view illustration of an exemplary in-ear headphone with an eartip according to some embodiments attached to the headphone housing;

FIG. 3B is a simplified side-view illustration of the in-ear headphone and eartip shown in FIG. 3A with the eartip detached from the headphone housing;

FIGS. 4A and 4B are simplified top-down view illustrations of exemplary eartips according to some embodiments disclosed herein;

FIG. 5A is a simplified cross-sectional view of an eartip according to some embodiments;

FIG. 5B is an exploded cross-sectional view of a portion of the eartip shown in FIG. 5A;

FIG. 6 is a simplified flowchart of a method of manufacturing an eartip according to some embodiments; and

FIGS. 7A to 7C are simplified cross-sectional views of an eartip at various stages of manufacture according to the method set forth in FIG. 6.

### DETAILED DESCRIPTION

Embodiments disclosed herein include eartips that provide improved passive attenuation for in-ear headphones without sacrificing comfort, stability or the ability of the eartip to provide a strong acoustic seal. Embodiments can block some background noise that might be present in the environment the eartips are used in from reaching the ear drum of the user and are particularly effective at reducing background noise in the mid and high frequency ranges.

While the disclosed eartips can be used with any in-ear headphones, they are particularly beneficial for in-ear headphones that include an active noise cancellation (ANC) feature. Some ANC systems are generally more effective at blocking low frequency sounds than they are at blocking higher frequency sounds. Embodiments described herein can be used with in-ear headphones having ANC systems to increase the passive attenuation of mid and high frequency sounds from background noise thereby improving the ANC capability of the in-ear headphones.

As described in detail below, eartips according to some embodiments include a monolithic silicone rubber member that defines a central sound channel. The monolithic silicone rubber member can include an inner body that defines the sound channel and a thin silicone outer body (sometimes referred to as a flange) that extends outward and downward from a tip of inner body in an umbrella-like shape that surrounds the inner body in a spaced apart relationship. Embodiments can include a layer of silicone foam that completely surrounds an upper portion of the sound channel extending along an outer portion of the inner body to an inner, upper portion of the flange thereby providing an improved passive attenuation capability of the eartip. Importantly, the silicone foam layer does not completely fill in all the space between the flange and the inner body. Instead, eartips according to embodiments described herein include an air gap (sometimes referred to as a “deflection zone”) between the flange and inner body that allows the flange to deform to the shape of the ear canal of a user when the eartip is inserted into the ear.

When inserted in the ear canal of a user, the layer of silicone foam can block sounds in the mid and high frequencies from traveling through the eartip to a user's ear drum. In some embodiments, the silicone foam layer can be created by adding expanding thermoplastic microspheres at selected locations on the eartip without increasing the stiffness of the eartip, which could otherwise interfere with comfort and fit. When attached to an in-ear headphone with an ANC system that is effective at blocking sound in the low frequencies, the eartips can improve the ANC capability by increasing the passive attenuation of mid and high frequency sounds from background noise.

### Example Wireless Listening System

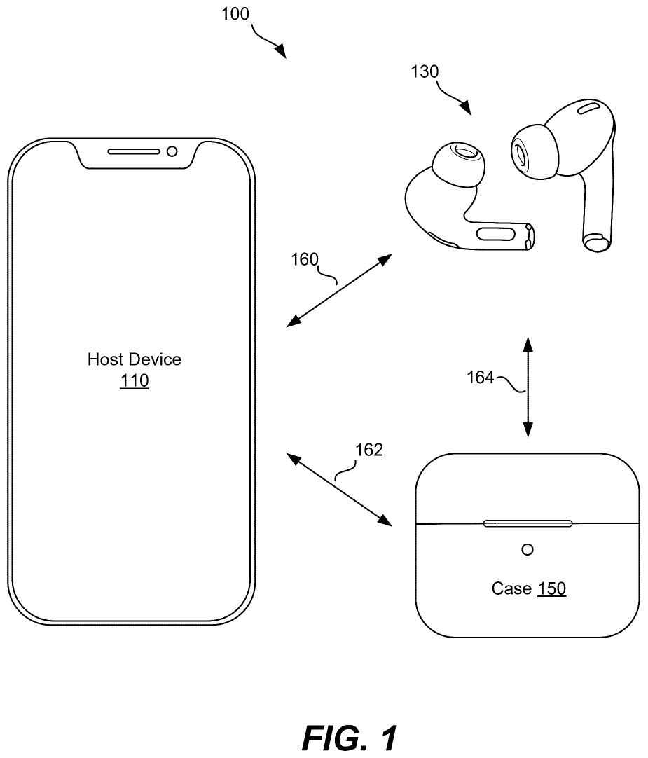

FIG. 1 is an example of a wireless listening system 100 according to some embodiments. System 100 can include a host device 110, a pair of wireless in-ear headphones 130 (e.g., left and right canal phones) and a charging case 150. Host device 110 is depicted in FIG. 1 as a smart phone but can be any electronic device that can transmit audio data to in-ear headphones 130. Other, non-limiting examples of suitable host devices 110 include a laptop computer, a desktop computer, a tablet computer, a smart watch, an audio system, a video player, and the like.

As depicted graphically in FIG. 1, host device 110 can be wirelessly communicatively coupled with wireless in-ear headphones 130 and charging case 150 through wireless communication links 160 and 162. Similarly, wireless in-ear headphones 130 can be communicatively coupled to charging case 150 via wireless communication link 164. Each of the wireless communication links 160, 162 and 164 can be a known and established wireless communication protocol, such as a Bluetooth protocol, a Wi-Fi protocol, or any other acceptable protocol that enables electronic devices to wirelessly communicate with each other. Thus, host device 110 can exchange data directly with wireless in-ear headphones 130, such as audio data, that can be transmitted over wireless link 160 to wireless listening devices 130 for play back to a user, and audio data that can be received by host device 110 as recorded/inputted from microphones in the wireless in-ear headphones 130. Host device 110 can also be wirelessly communicatively coupled with charging case 150 via wireless link 162 so that the host device 110 can exchange data with the charging case, such as data indicating the battery charge level data for case 150, data indicating the battery charge level for wireless in-ear headphones 130, data indicating the pairing status of wireless in-ear headphones 130.

Wireless in-ear headphones 130 can be stored within case 150, which can protect the devices 130 from being lost and/or damaged when they are not in use and can also provide power to recharge the batteries of wireless in-ear headphones 230 as discussed below. In some embodiments wireless in-ear headphones 130 can also be wirelessly communicatively coupled with charging case 150 via wireless link 164 so that, when the devices are worn by a user, audio data from case 150 can be transmitted to wireless in-ear headphones 130. As an example, charging case 150 can be coupled to an audio source different than host device 110 via a physical connection, e.g., an auxiliary cable connection. The audio data from the audio source can be received by charging case 150, which can then wirelessly transmit the data to in-ear headphones 130. That way, a user can hear audio stored on or generated by an audio source by way of in-ear headphones 130 even though the audio source does not have wireless audio output capabilities.

In some embodiments, wireless in-ear headphones 130 can include several features that enable the devices to be comfortably worn by a user for extended periods of time and even all day. For example, each in-ear headphone 130 can be shaped and sized to fit securely between the tragus and anti-tragus of a user's ear so that the in-ear headphone is not prone to falling out of the ear even when a user is exercising or otherwise actively moving. Its functionality can also enable the in-ear headphones 130 to provide a user interface to host device 110 so that the user may not need to utilize a graphical interface of host device 110 for certain functions or operations of either the wireless in-ear headphones or the host device. In other words, in-ear headphones 130 can be sufficiently sophisticated that they can enable the user to perform certain day-to-day operations from host device 110 solely through interactions with the headphones 130. This can create further independence from host device 110 by not requiring the user to physically interact with, and/or look at the display screen of, host device 110, especially when the functionality of in-ear headphones 130 is combined with the voice control capabilities of host device 110. Thus, in some instances wireless in-ear headphones 130 can enable a true hands-free experience for the user.

### Example In-Ear Headphone

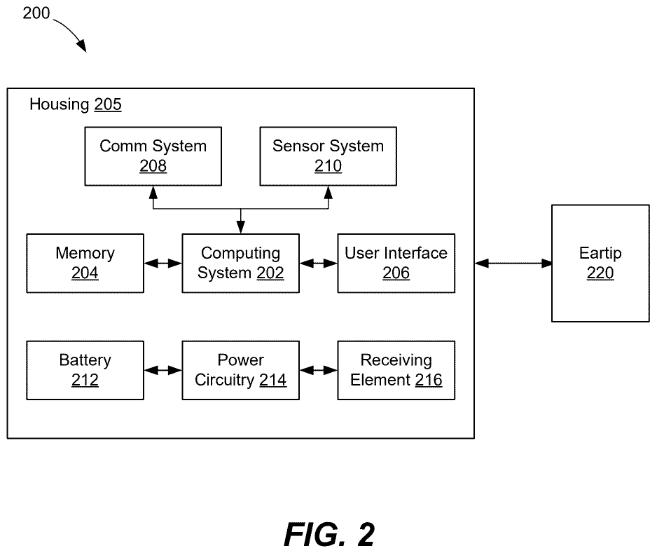

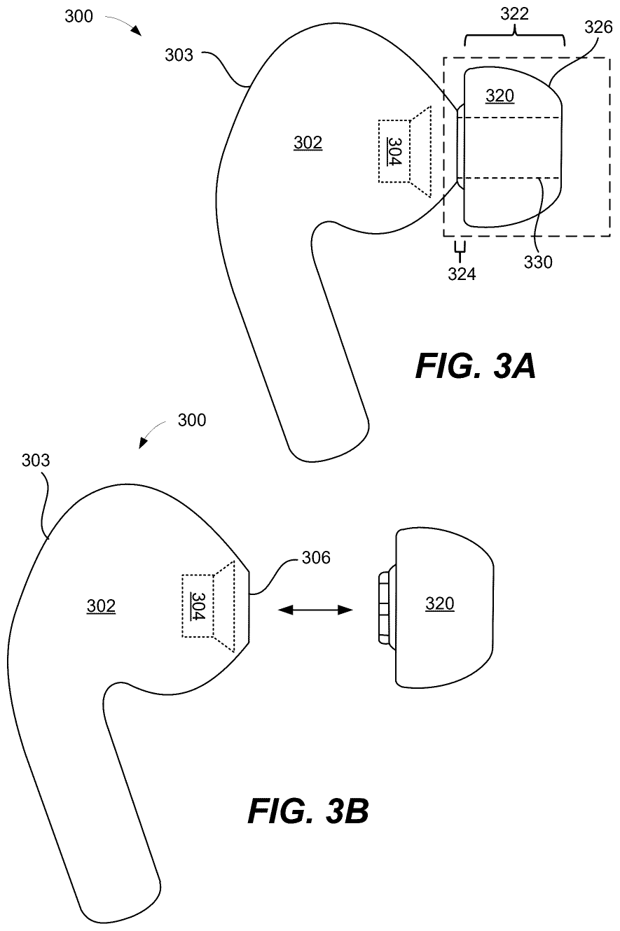

Details of an example in-ear headphone, which can be representative of each of the wireless in-ear headphones 130 are discussed below with respect to FIG. 2 and FIGS. 3A and 3B. Reference is first made to FIG. 2, which is a simplified block diagram illustrating an in-ear headphone 200 according to some embodiments. As shown, in-ear headphone 200 can include a computing system 202 coupled to a computer-readable memory 204. Computing system 202 can execute instructions stored in memory 204 for performing various functions of in-ear headphone 200. Computing system 202 can be one or more suitable computing devices, such as microprocessors, microcontrollers, computer processing units (CPUs), graphics processing units (GPUs), application specific circuits (ASICs), field programmable gate arrays (FPGAs), and the like.

Computing system 202 can also be coupled to a user interface system 206, a communication system 208, and a sensor system 210 for enabling in-ear headphones 200 to perform one or more functions. For instance, user interface system 206 can include an acoustic driver (e.g., speaker) for outputting sound to a user, a microphone for inputting sound from the environment or the user, and any other suitable input and output device. Communication system 208 can include Bluetooth components for enabling housing 205 to send and receive data/commands from a host device, such as host device 110 shown in FIG. 1. The host device, to which in-ear headphone 200 can be considered an accessory, can be a portable electronic device, such as a smart phone, tablet, or laptop computer. The host device can include a host communication system that can communicate with communication system 208 via a wireless communication line so that the host device can send sound data to headphone 200 to output sound and receive data from headphone 200 to receive user inputs. Sensor system 210 can include optical sensors, proximity sensors, accelerometers, microphones, and any other suitable type of sensor that can measure a parameter of an external entity and/or environment.

In-ear headphone 200 can also include a battery 212, which can be any suitable energy storage device, such as a rechargeable lithium-ion battery, capable of storing energy and discharging stored energy to operate housing 205. The discharged energy can be used to power the electrical components of headphone 200. In some embodiments, battery 212 can also be charged to replenish its stored energy. For instance, battery 212 can be coupled to a power receiving circuitry 214, which can receive current from a receiving element 216. Receiving element 216 can electrically couple with a transmitting element of an external charging device, such as charging case 150 shown in FIG. 1.

In some embodiments, computing system 202 can also implement an active noise cancellation (ANC) system. For example, one or more microphones of the in-ear headphones can be positioned to detect sounds in the environment surrounding the in-ear headphones. Computing system 202 can receive input from the microphones and control the audio driver to generate sound waves with the opposite phase to effectively cancel out the unwanted noise by creating destructive interference when the two waves meet at the user's ear drum. Such ANC systems can result in an improved user experience by effectively canceling out background noise present in the user's environment making for a quieter and more enjoyable listening experience with improved sound clarity.

In-ear headphone 200 can include a deformable eartip 220 that, when the eartip is inserted into a user's ear canal, can form a seal with the inner wall of the ear canal partially attenuating or partially blocking out external noises. The seal between a deformable eartip, such as eartip 220, and the user's ear canal can form a closed acoustic architecture that enables the in-ear headphone to have improved noise cancellation features as opposed to earphones that have an open acoustic architecture. Additionally, in some embodiments eartip 220 can be specifically designed to, when attached to in-ear headphone 200, provide an increased level of passive attenuation for the in-ear headphone, as will be discussed further herein, while achieving a comfortable fit in a user's ear canal and also achieving high acoustic performance. In some embodiments, eartip 220 can attach to, and detach from, in-ear headphone 200 as discussed below with respect to FIGS. 3A and 3B.

FIG. 3A is a side-view illustration of an exemplary in-ear headphone 300 including a housing 302 and an eartip 320, according to some embodiments, attached to housing 302; and FIG. 3B is a side view illustration of in-ear headphone 300 where eartip 320 is detached from housing 302. As shown in FIG. 3A, eartip 320 can include a tip region 322 and a base region 324. A sound channel 330 can extend through both tip region 322 and base region 324. When eartip 320 is attached to housing 302, the sound channel aligns with an acoustic port 306 formed through a wall of housing 302 that directs sound generated by an acoustic driver 304 through acoustic port 306 and through sound channel 330.

Tip region 322 can include a curved, outer body 326, sometimes referred to as a flange, which extends fully around the eartip and can be inserted into an ear canal of a user so that sound channel 330 can direct sound from housing 302 to the user. Outer body 326 can be formed of a pliable material, such as silicone, which can easily bend to conform to the inner surfaces of the ear canal for forming an acoustic seal.

Eartip 320 can be detached from housing 302, as shown in FIG. 3B, so that damaged eartips can be easily replaced or so that different types and/or sizes of eartips can be used to more comfortably fit in ear canals of different anatomical shapes and sizes.

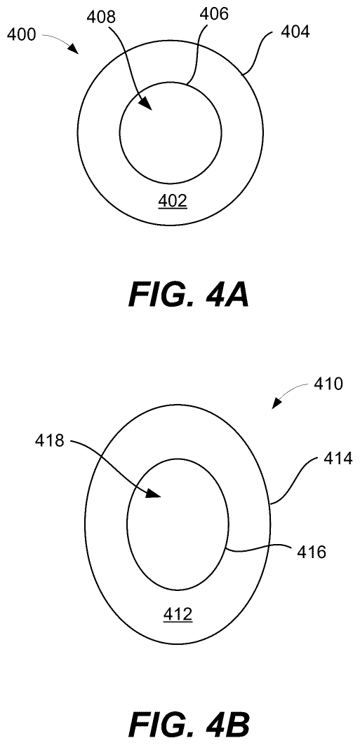

In some embodiments, eartip 320 can have various profile shapes. For instance, FIG. 4A is a top-down view illustration of an exemplary eartip 400 configured with a circular profile, according to some embodiments of the present disclosure. When configured with a circular profile, the flange 402 of eartip 400 can have a substantially circular outer diameter 404 and inner diameter 406, which forms a circular sound channel 408. Being configured with a circular profile enables eartip 400 to easily bend in all directions. However, some portions of ear canals may not have a substantially circular cross-sectional shape and thus may be difficult for eartip 400 to achieve a proper fit. Thus, in some embodiments, an eartip can be configured to have profiles configured in other shapes.

FIG. 4B is a top-down view illustration of an exemplary eartip 410 configured with an ovular profile, according to some embodiments of the present disclosure. When configured with an ovular profile, the flange 412 of eartip 410 can have a substantially ovular outer diameter 414 and inner diameter 416, which forms an ovular sound channel 418. The ovular profile allows eartip 410 to more easily conform to the natural shape of some portions of ear canals.

The seal between any of the deformable eartips described above and the user's ear canal can form a closed acoustic architecture that enables an in-ear headphone to have improved noise cancellation features as opposed to earphones that have an open acoustic architecture. As discussed below, eartips according to embodiments described herein provide further improvement to noise cancellation features by providing improved passive attenuation of mid and high frequency sounds that are present in the background noise or environment in which in-ear headphones are used.

### Eartips with Improved Passive Attenuation

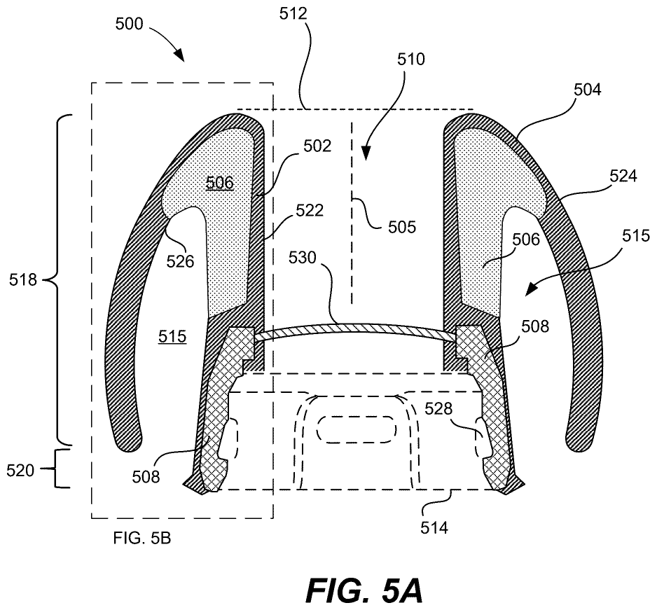

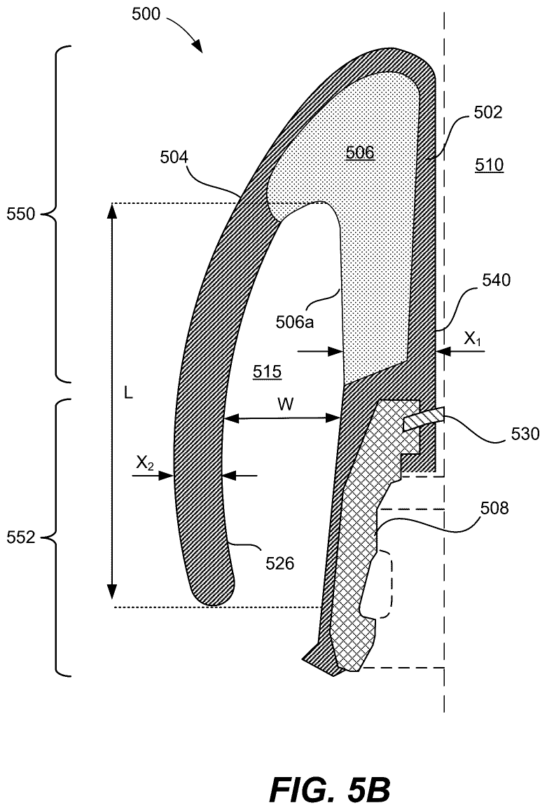

FIG. 5A is a simplified cross-sectional view of a deformable eartip 500 with improved passive attenuation according to some embodiments. As shown in FIG. 5A, eartip 500 can include an inner eartip body 502, an outer eartip body (sometimes referred to as a flange) 504, and a silicone foam passive attenuation layer 506 (sometimes referred to as “silicone foam section” or “silicone foam insert”) that extends between the inner eartip body and flange. In some embodiments, inner eartip body 502 and flange 504 can be part of a single, monolithic structure.

Inner eartip body 502 is centered along a central axis 505 and defines a sound channel 510 that extends through the entire length of eartip 500. The sound channel is an empty space through which sound travels from an audio driver within the in-ear headphone to which eartip 500 is attached to a user's eardrum. Outer eartip body 504 and inner eartip body 502 are joined at one end of the eartip 500 (an ear interfacing end 512) with the outer eartip body 504 extending outwardly away from, and in a spaced apart relationship with, the inner eartip body towards the second, opposite end of eartip 500 (an earphone attachment end 514) in a dome-like or umbrella-like shape creating a gap or vacant space 515 between the outer and inner eartip bodies along at least a portion of a length of eartip 500.

As depicted, eartip 500 can include a tip region 518 and a base region 520 (e.g., tip region 206 and base region 208 in FIG. 2). Tip region 518 can be a part of eartip 500 that inserts into the ear canal of the user while base region 520 can be a part of eartip 500 that extends toward and attaches to an attachment structure of the in-ear headphone. When eartip 500 is attached to an in-ear headphone, ear-interfacing end 512 can face away from the earphone and sound channel 510 can be substantially aligned with an acoustic opening of the headphone (e.g., acoustic opening 306 shown in FIG. 3B) so that sound the from the headphone housing can easily propagate into sound channel 510.

In order to provide a comfortable fit within a user's ear, outer eartip body 504 can be formed from a relatively thin and highly compliant material, such as silicone rubber, that enables the outer eartip body, when inserted into an ear canal, to compress and bend into vacant space 515 to conform to the contours of the ear canal and form an acoustic seal that blocks sounds from entering the ear canal as ambient noise. To allow outer eartip body 504 to deflect inward and outward, outer eartip body 504 can be like a cantilever where its end closest to the earphone attachment end 514 is positioned a distance away from inner eartip body 502 to define gap 515, which can be referred to as a deflection zone, formed of vacant space within which outer eartip body 504 can freely deflect.

Inner eartip body 502 and outer eartip body 504 can be a monolithic structure such that inner eartip body 502 is formed of the same material (e.g., silicone rubber) as the outer eartip body. The inner eartip body 502 can include an inner surface 522 that extends along a length of, and defines, sound channel 510. Silicone rubber has a closed-cell structure and is particularly suitable for inner and outer eartip bodies 502, 504 due to its durability and flexibility among other characteristics.

Inner eartip body 502 does not contact a user's ear canal and thus does not need to be as compliant as outer eartip body 504 for conforming to the ear canal. In view of such, in some embodiments, the portion of eartip 500 that surrounds sound channel (i.e., inner eartip body 502 and a portion of silicone foam layer 506) can be thicker than that of the outer eartip body.

Outer eartip body 504 can include a curved exterior surface 524 that makes contact with the inner surfaces of a user's ear canal for forming an acoustic seal when the in-ear headphone is worn by the user. Outer eartip body 504 can taper toward ear-interfacing end 512 to make it easier for the user to insert eartip 500 into his or her ear canal. In the embodiment depicted in FIG. 5A, a part of outer eartip body 504 closest to attachment end 514 can bend back toward inner eartip body 502 to reduce the chances of outer eartip body 504 flipping inside-out.

Notably, eartip 500 also includes a silicone foam section 506 that comprises a softer, silicone foam material. Silicone foam section 506 can be formed over an upper portion of an outer surface of inner eartip body 502 and extend fully around sound channel 510. As shown, the silicone foam section can also extend along a portion of an inner surface 526 of outer eartip body 504 partially filling in space between the inner and outer eartip bodies near ear-interfacing end 512 of eartip 500. In this manner, silicone foam section 506 forms both a portion of the overall wall that defines the sound channel (i.e., a portion of inner eartip body 502 and a portion of silicone foam section 506 combine to form the sound channel wall) and a portion of the annular flange. Importantly, silicone foam section 506 does not completely fill in the gap between the inner and outer eartip bodies 502, 504 preserving deflection zone 515.

To illustrate in more detail, reference is made to FIG. 5B, which is an exploded cross-sectional view of a portion of eartip 500. As depicted in FIG. 5B, silicone foam section 506 includes a portion 506a that is formed over an outer surface of inner eartip body 502 and extends along a height of eartip 500. Thus, from a certain perspective eartip 500 can be considered as being divided into an upper portion 550 that includes silicone foam section 506 and a lower portion 552 from which the silicone foam section is absent. In the depicted embodiment, upper and lower portions 550, 552 are each approximately an equal 50 percent of the total height of the eartip, but embodiments are not limited to such, and in other embodiments the upper portion 550 can be more or less than 50 percent of the eartip height. For example, in various embodiments, upper portion 550 can be between 20-80 percent of the height of eartip 500, between 30-70 percent of the height of eartip 500 or between 40-60 percent of the height of eartip 500.

Additionally, as can be seen in FIGS. 5A and 5B, portion 506a of silicone foam section 506 combines with the inner eartip body 502 to form an inner wall 540 of the eartip. Inner wall 540 fully surrounds sound channel 510 and provides structure to eartip 500. In some embodiments, inner wall 540 has a thickness X₁ that is considerably thicker than a thickness X₂ of flange 504. For example, and knowing that FIGS. 5A and 5B are simplified figures that are not necessarily drawn to scale, in some embodiments, inner wall 540 is, at its narrowest portion, at least twice as thick as flange 504. In other embodiments, inner wall 540 is at least three times as thick, at least five times as thick or at least ten times as thick as flange 504.

As also can be seen in FIGS. 5A and 5B, eartip 500 includes a deflection zone 515 that extends along a majority of the height of eartip 500 and allows flange 504 to be compressed and bent into the empty space provided by the deflection zone 515 when eartip 500 is inserted into a user's ear canal. In various embodiments, deflection zone has a length, L, which is at least 75 percent, at least 60 percent or at least 50 percent of a total height of eartip 500. In some embodiments, the length, L, of deflection zone is at least 4 mm, at least 6 mm or at least 8 mm long. With respect to its width, at its widest point, deflection zone 515 has a width, W, which is at least five times greater, at least eight times greater than, or at least 10 times greater than the thickness, X₂, of flange 504. Also, in various embodiments, W is at least 3 mm or at least 4 or at least 5 mm wide.

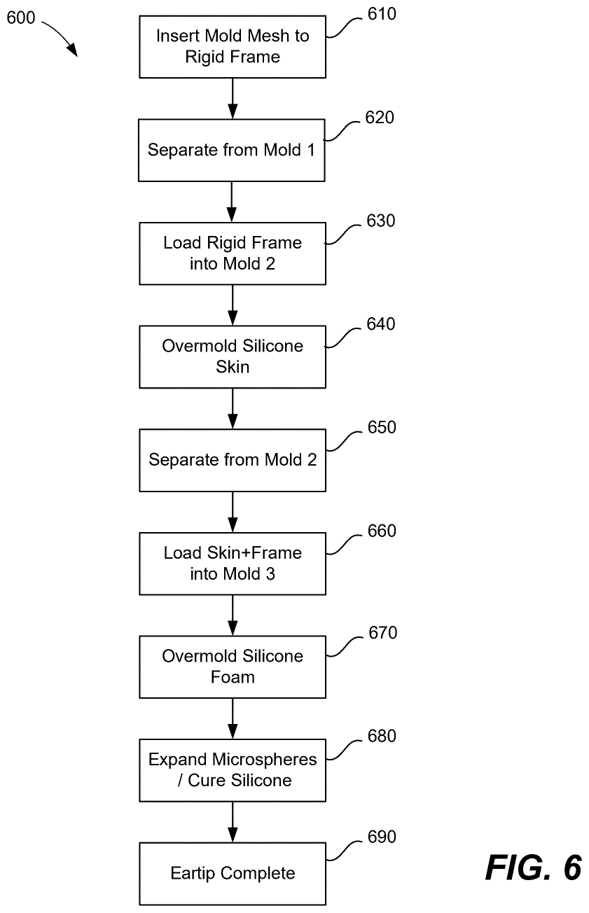

In some embodiments silicone foam section 506 can be made from thermoplastic microspheres injected into a mold and heated to expand in size during a multi-shot manufacturing process as explained below in conjunction with FIG. 6. The silicone foam that makes up silicone foam section 506 can have a closed-cell structure, and thus layer 506 is sometimes referred to herein as “closed-cell silicone foam layer 506”. The closed-cell structure of layer 506 provides good sealing capabilities and makes the layer resistant to moisture absorption. Silicone foam section 506 can, however, be notably softer than the closed-cell silicone material that makes up inner and outer eartip bodies 502, 504. The microspheres included within silicone foam layer 506 enable layer 506 to trap air better than the denser silicone rubber of the inner and outer eartip bodies enabling the closed-cell silicone foam layer to be more effective at absorbing higher frequency sound waves.

In some embodiments, inner and outer eartip bodies 502, 504 comprise a silicone rubber material that has a density of between 1.1 and 1.8 g/cm³ or between 1.2 and 1.5 g/cm³ while the silicone foam in silicone foam section 506 has a density that can be 10-60% lower than that of the silicone rubber in the outer eartip body. For example, in some embodiments the silicone foam layer 506 has a density of between 0.7 and 1.0 g/cm³ or between 0.8 and 0.9 g/cm³ in other embodiments. Additionally, in some embodiments the silicone rubber material has a durometer of between about 25-45A (Shore A), and preferably between 30-40A, while the silicone foam has a durometer of between about 12-25, and preferably between 15-20A.

Referring back to FIG. 5A, in some embodiments eartip 500 can include an attachment structure 508 at attachment end 514 for securely attaching eartip 500 to the housing of an in-ear headphone. As mentioned herein, inner eartip body 502 can be formed of a compliant material such as silicone rubber, while the housing of most earphones is formed from a relatively hard and stiff material, such as glass-reinforced nylon, acrylonitrile butadiene styrene (ABS) or a similar thermoplastic polymer. Compliant materials may not easily attach to stiff structures alone. Thus, in some embodiments, attachment structure 508 can be a rigid frame that enables the eartip 500 to be removably attached to a suitable structure (not shown) on the housing of an in-ear headphone so that sound generated by the housing can pass into sound channel 510 through an acoustic opening of the in-ear headphones. As a non-limiting example, in some embodiments attachment structure 508 can be formed from a stiff, rigid material, such as plastic or thermal plastic urethane (TPU), that is strong enough to achieve the desired attachment characteristic.

As one example, attachment structure 508 can include a plurality of recesses 528 spaced radially around a lower region of the attachment structure for providing latching points for an attachment mechanism (e.g., a spring clip) of the in-ear headphones to attach. Recesses 528 can be cavities formed in an inner surface of attachment structure 508 that passively allow a headphone attachment mechanism to secure eartip 500 to the in-ear headphone housing. For instance, portions of the lower region below recesses 528 can form an inverted overhang structure that hooks onto an external structure, such as an end cap of a headphone attachment structure.

Attachment structure 508 can include a mesh 530 for preventing debris and other unwanted particles from falling into the earphone housing through sound channel 510 and the acoustic port in the earphone housing. Mesh 530 can be an interlaced structure formed of a network of wire that allows sound to propagate through but prevents debris from passing through. In some embodiments, mesh 530 extends into a portion of attachment structure 508 so that mesh 530 can be securely fixed within eartip 500 by the rigid structure of attachment structure 508.

### Method of Manufacturing Eartip with Improved Passive Attenuation

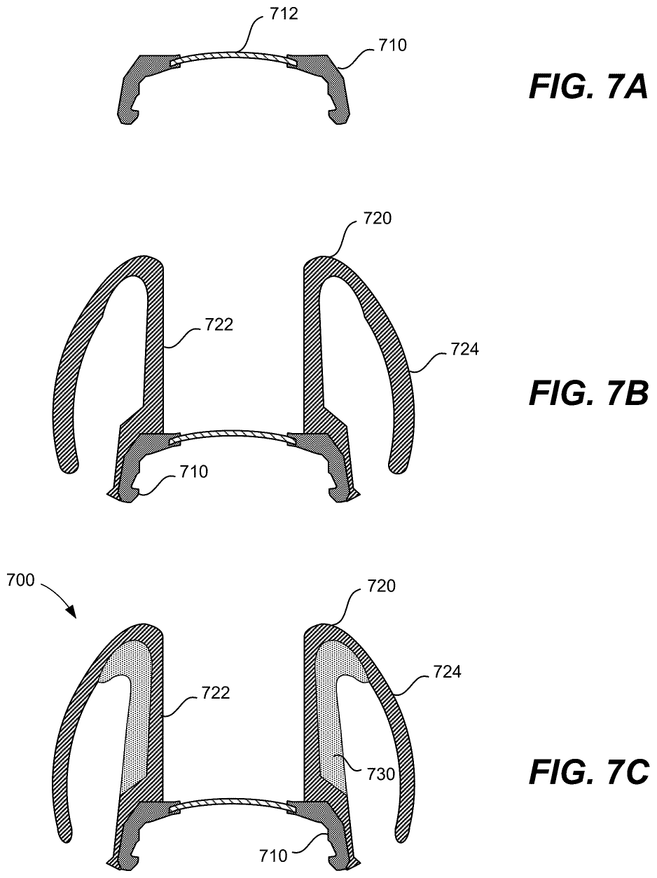

While eartips with improved passive attenuation as disclosed herein can be manufactured using a variety of different suitable techniques, some embodiments are made using a multi-step liquid injection molding process for the silicone rubber molding steps. To illustrate, reference is made to FIG. 6 and FIGS. 7A-7C where FIG. 6 is a simplified flowchart of a method 600 of manufacturing an eartip 700 according to some embodiments and FIGS. 7A-7C are simplified cross-sectional views of eartip 700 at different stages of manufacture. While method 600 is described with respect to forming eartip 700, it can be appreciated that method 600 can be carried out to manufacture any of eartips with improved passive attenuation described herein and that eartip 700 can be representative of any of eartips 220, 320, 400, 410 and 500.

Referring first to FIGS. 6 and 7A, method 600 can begin by forming a rigid eartip frame 710 (FIG. 6, block 610; FIG. 7A), such as frame 508 discussed above. In some embodiments, eartip frame 710 can be made from a relatively hard and stiff material, such as glass-reinforced nylon, ABS or a similar thermoplastic polymer, and can be formed in an insert molding process in which a mesh (e.g., mesh 712) is placed in a mold and an appropriate material, such as a composite of nylon and glass fibers, is injected into the mold to form the rigid frame around the mesh. In other embodiments, the eartip frame can be made using an injection molding process, a 3D printing process, vacuum forming or other suitable techniques. In some embodiments, block 610 can also include attaching a mesh 712 to frame 710 instead of forming the frame around the mesh.

Once formed, eartip frame 710 can then be separated from the first mold (FIG. 6, block 620) and loaded into an injection mold tool (FIG. 6, block 630). Liquid silicone rubber can then be injected into the cavity of the injection tool and cured to form a thin, hardened silicone skin 720 (FIG. 6, block 640; FIG. 7B). During the injection molding process of block 640, the mold cavity and core (collectively referred to as the “second mold”) combine to define the shape of skin 720 such that both an inner eartip body 722 (e.g., inner eartip body 502) and outer eartip body 724 (e.g., outer eartip body 504) are formed from skin 720. At this stage, rigid frame 710 and silicone skin 720 combine to form a partially formed eartip as shown in FIG. 7B.

Next, the partially formed eartip can be separated from the second mold and removed from the first silicone injection molding tool (FIG. 6, block 650). The partially formed eartip can then be loaded into another silicone injection molding tool (FIG. 6, block 660) where expandable thermoplastic microspheres (typically in the form of a fine powder) are mixed with liquid silicone rubber and injected into the mold cavity (FIG. 6, block 670). During the injection molding process of block 670, the mold cavity and core (collectively referred to as the “third mold”) combine to define the shape of silicone foam section 730, such that the silicone thermoplastic microsphere mixture layers over a portion of an outer surface of inner eartip body 722 and wraps around to an inner surface of outer eartip body 724.

After the silicone thermoplastic microsphere mixture is injected into the area of silicone foam section 730, the eartip can be heated to expand the microspheres. The microspheres can include an outer shell made from a thermoplastic polymer. The heating process can soften the outer shell of the microsphere allowing gas (e.g., hydrocarbon gas) trapped within the microspheres to expand thus expanding the shell of the microspheres. After the liquid silicone rubber mixed with thermoplastic is injected into the heated mold, the material heats causing the microspheres to expand. The silicone rubber material cures soon after the microspheres have expanded under the heat of the tool, which locks in closed-cell air bubbles into the foamed silicone material 730 (FIG. 6, block 680). In some embodiments, an instant runner removal process can be used for the injection molding process in order to impact the cycle time and the cooling process in a manner that increases porosity.

A variety of different types of thermoplastic microsphere powders are available to be mixed with liquid silicone rubber in block 670. As can be appreciated, a person of skill in the art can select an appropriate thermoplastic microsphere powder, select an appropriate liquid silicone rubber to mix the powder with, and determine an appropriate ratio of powder to liquid silicone rubber and an appropriate heating time and temperature to obtain a silicone foam passive attenuation layer having desired properties. In some embodiments, a thermoplastic microsphere powder having microspheres with a mean particle size between 5 and 40 microns when unexpanded can be used that, when heated at temperatures above 80 or above 90 degrees Celsius begin to expand. In some embodiments, the thermoplastic microspheres can expand during block 680 to between at least two to twelve times their initial, unexpanded particle size. In some particular embodiments, the thermoplastic microsphere powder is chosen in block 670 so that, when expanded, the microspheres present in silicone foam passive attenuation layer have a mean particle size between 60 and 120 microns. Also, while embodiments are not limited to any particular ratio of thermoplastic microspheres to liquid silicone rubber, in some embodiments the ratio is between 0.25-10% (loading percent by weight) and in other embodiments the ratio is between 1-5%.

Instead of adding expandable microspheres in block 670 and heating the eartips to expand the microspheres in block 680, some embodiments can incorporate pre-expanded microspheres into the liquid silicone rubber. In such embodiments, the microspheres can be thermally expanded before being incorporated into the silicone rubber mixture and then the mixture of pre-expanded microspheres and silicone rubber can be injected into the mold cavity. In embodiments, the pre-expanded microspheres can be mixed into the uncured silicone at similar loading levels (e.g., between 0.25-10.0 wt %) as the expandable microspheres, and then molded into the formed shape and cured.

Once passive attention layer 730 is fully formed, eartip 700 is completed (FIG. 6, block 690; FIG. 7C), and can be removed from the second mold and is ready to be attached to an appropriate in-ear headphone.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. For example, while embodiments of eartips described above include a rigid attachment structure that enable the eartips to be easily attached and detached to the housing of certain in-ear headphones, some embodiments do not include a rigid attachment structure. Instead, in some embodiments the inner eartip body, which is made of a flexible elastomer material such as silicone rubber, of some eartips disclosed herein can be stretched and inserted over a nozzle or similar structure formed on the housing of an in-ear headphone.

As another example, while the examples of in-ear headphones disclosed herein are wireless in-ear headphones, eartips according to embodiments discussed herein can also be used with wired in-ear headphones. As still another example, in some embodiments a mesh can be formed over an acoustic port or nozzle of the in-ear headphone instead of, or in addition to, a mesh 530 or 712 shown in the examples above.

Thus, the foregoing descriptions of the specific embodiments described herein are presented for purposes of illustration and description. They are not intended to be exhaustive or to limit the embodiments to the precise forms disclosed. Also, while different embodiments of the invention were disclosed above, the specific details of particular embodiments may be combined in any suitable manner without departing from the spirit and scope of embodiments of the invention. Further, it will be apparent to one of ordinary skill in the art that many modifications and variations are possible in view of the above teachings.

Finally, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A deformable eartip comprising:
a monolithic silicone rubber eartip body comprising: (i) an annular inner body having an inner surface extending between first and second opposing ends thereby defining a sound channel through the deformable eartip, (ii) and an annular outer flange integrally formed with and surrounding the first end of the annular inner body and extending towards the second end of the annular inner body in a spaced apart relationship with the annular inner body;
a closed-cell silicone foam section formed on and completely surrounding a portion of an outer surface of the annular inner body adjacent to the first end and extending to the outer flange thereby filling in space between the annular inner body and outer flange, wherein the closed-cell silicone foam layer and annular inner eartip body combine to form a portion of an inner wall of the eartip that surrounds the sound channel;
a deflection zone formed between the annular outer flange and the inner wall; and
an annular rigid frame coupled to the second end of the annular inner body and defining a central frame opening formed through the frame that is aligned with the sound channel formed through the annular inner body.

2. The deformable eartip of claim 1 wherein the closed-cell silicone foam section comprises a plurality of microspheres having a mean particle size between 60 and 120 microns.

3. The deformable eartip of claim 1 wherein the closed-cell silicone foam section is formed from a mixture of thermoplastic microspheres and liquid silicone rubber.

4. The deformable eartip of claim 1 wherein the closed-cell silicone foam section is formed from a mixture of thermoplastic microspheres having a mean particle size between 5-40 microns and liquid silicone rubber.

5. The deformable eartip of claim 1 wherein the monolithic silicone rubber eartip body has a density between 1.1 and 1.8 grams/cm³.

6. The deformable eartip of claim 5 wherein the closed-cell silicone foam section has a density that is between 10-60 percent lower than the density of the monolithic silicone rubber eartip body.

7. The deformable eartip of claim 5 wherein the closed-cell silicone foam section has a density between 0.7 and 0.9 grams/cm³.

8. The deformable eartip of claim 1 wherein the eartip is formed with a triple shot injection molding process in which one shot forms the frame, a second shot forms the outer flange and the inner eartip body and a third shot forms the closed-cell silicone foam section.

9. The deformable eartip of claim 1 wherein the deflection zone has a width, at its widest point, of at least 3 mm and a length of at least 5 mm.

10. The deformable eartip of claim 1 wherein the annular rigid fame comprises glass-reinforced nylon.

11. A deformable eartip comprising:
an annular inner eartip body having an inner surface extending between first and second opposing ends thereby defining a sound channel through the eartip;
an annular outer flange integrally formed with and surrounding the first end of the inner eartip body and extending towards the second end of the inner eartip in a spaced apart relationship with the annular inner eartip body;
a closed-cell silicone foam section formed on and completely surrounding an outer surface of the inner eartip body and extending to the outer flange thereby filling in space between the inner eartip body and outer flange near a tip of the eartip, whereby the closed-cell silicone foam section and annular inner eartip body combine to form a portion of an inner wall of the eartip that surrounds the sound channel; and
a deflection zone formed between the annular outer flange and the inner wall, the deflection zone being sized and shaped to allow the annular outer flange to be compressed and bent into the deflection zone when the deformable eartip is inserted into an ear canal.

12. The deformable eartip of claim 11 further comprising an annular rigid frame coupled to the second end of the annular eartip body and defining a central frame opening formed through the frame that is aligned with the sound channel formed through the annular eartip body.

13. The deformable eartip of claim 11 wherein the closed-cell silicone foam section is formed from a mixture of thermoplastic microspheres and liquid silicone rubber.

14. The deformable eartip of claim 11 wherein the monolithic silicone rubber eartip body has a density between 1.1 and 1.8 grams/cm³.

15. The deformable eartip of claim 11 wherein the closed-cell silicone foam section has a density that is between 10-60 percent lower than the density of the monolithic silicone rubber eartip body.

16. An in-ear headphone comprising:
a housing defining a cavity and an acoustic opening;
an acoustic driver positioned within the housing and operatively coupled to emit sound through the acoustic opening; and
a deformable eartip removably attached to the housing and aligned with the acoustic opening, the deformable eartip comprising:
a monolithic silicone rubber eartip body comprising: (i) an annular inner body having an inner surface extending between first and second opposing ends thereby defining a sound channel through the deformable eartip, (ii) and an annular outer flange integrally formed with and surrounding the first end of the annular inner body and extending towards the second end of the annular inner body in a spaced apart relationship with the annular inner body;
a closed-cell silicone foam section formed on and completely surrounding a portion of an outer surface of the annular inner body adjacent to the first end and extending to the outer flange thereby filling in space between the annular inner body and outer flange, wherein the closed-cell silicone foam layer and annular inner eartip body combine to form a portion of an inner wall of the eartip that surrounds the sound channel;
a deflection zone formed between the annular outer flange and the inner wall; and
an annular rigid frame coupled to the second end of the annular inner body and defining a central frame opening formed through the frame that is aligned with the sound channel formed through the annular inner body.

17. The deformable eartip of claim 16 wherein the closed-cell silicone foam section is formed from a mixture of thermoplastic microspheres and liquid silicone rubber.

18. The deformable eartip of claim 16 wherein the monolithic silicone rubber eartip body has a density between 1.1 and 1.8 grams/cm³ and the closed-cell silicone foam section has a density that is between 10-60 percent lower than the density of the monolithic silicone rubber eartip body.

19. The deformable eartip of claim 18 wherein the closed-cell silicone foam section has a density between 0.7 and 0.9 grams/cm³.

20. The deformable eartip of claim 16 wherein the eartip is formed with a triple shot injection molding process in which one shot forms the frame, a second shot forms the outer flange and the inner eartip body and a third shot forms the closed-cell silicone foam section.
